(19) United States
(12) Patent Application Publication
(10) Pub. No.: US 2008/0083482 A1
(43) Pub. Date: Apr. 10, 2008

(54) Method for adhering an electronic device to a tire inner liner

(76) Inventor: Brian Matthew Logan, Akron, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/545,141

(22) Filed: Oct. 10, 2006

(51) Int. Cl. B29C 35/00

(52) U.S. Cl. 156/110.1; 152/152.1

(57) ABSTRACT

A method for attaching an object against a tire inner liner by means of an adhesive, including: applying uncured adhesive between the tire inner liner and the object; selecting at least one adhesion enhancing agent from the group: air pressure, steam, moisture, heat, radiation; adding the adhesion enhancing agent to the interior of the tire while the adhesive is in an at least partially uncured state; and curing the adhesive. Air pressurization of the tire cavity may be employed as an adhesion enhancing agent to press the object against the inner liner as the adhesive cures. The air pressure operational parameters may be predetermined and selected to complement adhesive cure properties and the air pressure of the tire cavity may be varied during at least part of the adhesive cure cycle. The adhesive may be a layer of rubber patch material.

### FIELD OF THE INVENTION

The subject invention relates generally to the attachment of an object against a tire inner liner and, more specifically, to the method of attaching electronic devices against a tire inner liner by means of adhesive compounds.

### BACKGROUND OF THE INVENTION

Electronic devices, such as pressure monitoring devices or RFID tags, are utilized within the tire industry and are attached to tires for accomplishing their intended function. The devices may include an antenna in the form of an annular ring or a dipole helically wound configuration. The RFID tags or pressure monitoring devices may be incorporated into a patch prior to a procedure for attaching the patch against a tire inner liner. Attachment to a tire may occur during tire manufacture. More commonly, however, such devices are attached to a tire as a post-manufacture procedure in order to minimize device malfunctions or failure.

It is imperative that adhesive attachment of electronic devices to a tire be secure and capable of withstanding the rigors of tire use. Maintaining the integrity of an attachment between an electronics device and a tire throughout the life of the tire is directly related to first establishing an effective bond between the device and the tire. The known and used procedure for attaching a device to a tire within the industry includes applying an uncured adhesive to the tire, pressuring the device into the adhesive, and subsequently allowing the adhesive to dry (cure). The contact pressure on the device to the adhesive and the adhesive to the liner is limited to a brief installation time and then removed, allowing the adhesive to subsequently cure in a room at atmospheric pressure.

While the aforementioned procedure can effectively bond the electronic device to the tire, it can create a less than optimal adhesive bond. Removal of contact pressure against the electronic device before the adhesive is fully cured can result in a bond that has structural deficiencies. Moving the tire prior to a full cure of the tire can also weaken the adhesive bond between the electronic device and the tire, resulting in a failure of the bond at a subsequent point in the working life of the tire.

Accordingly, the industry is in need of an improved method for adhering an object to a tire inner liner. The procedure, in order to meet the needs of the industry, should be inexpensive to implement and operate expeditiously to effect a positive bond between an object such as an electronic device and the tire. An acceptable procedure will not negatively impact manufacturing time or efficiencies.

### SUMMARY OF THE INVENTION

In one aspect, the invention is a method for attaching an object against a tire inner liner by means of an adhesive, comprising applying the adhesive in an uncured state between the tire inner liner and the object and adding an adhesion enhancing agent to the interior of the tire for enhancing adhesion between the tie inner liner and the object for at least a portion of an adhesion cure cycle. The adhesion enhancing agent may include air pressure, steam, moisture, heat, and/or radiation.

Pursuant to another aspect of the invention, the adhesion enhancing agent may include air pressure introduced into the tire to press the object against the inner liner as the adhesive cures. The air pressure operational parameters may be predetermined and selected to complement adhesive cure properties. In another aspect of the invention, the air pressure may be varied during at least part of the adhesive cure cycle.

A further aspect of the invention is a method for attaching an object against a tire inner liner by means of an adhesive, including: applying uncured adhesive between the tire inner liner and the object; selecting at least one adhesion enhancing agent from the group: air pressure, steam, moisture, heat, radiation; adding the adhesion enhancing agent to the interior of the tire while the adhesive is in an at least partially uncured state; and curing the adhesive.

### BRIEF DESCRIPTION OF THE DRAWINGS

The invention will be described by way of example and with reference to the accompanying drawings in which:

FIG. 1 is a block level diagram of the method of the subject invention.

FIG. 2 is a graph of adhesion values and the force variation between thick and thin adhesion values.

FIG. 3 is a partial schematic of a tire, cavity, and device attached to the tire liner by adhesive.

### DETAILED DESCRIPTION OF THE INVENTION

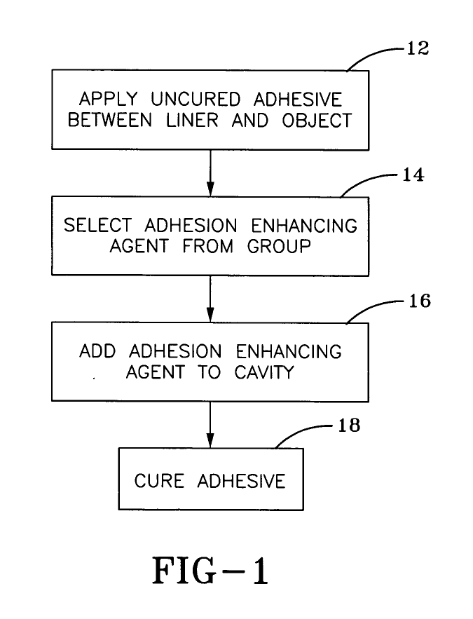

Referring to FIG. 1, the subject method 10 is intended for the purpose of installing an object to the inside liner of a tire. As used herein, “object” is used in a general sense. However, one useful application of the principles of the invention is for attaching an RFID tag or other electronic device to a tire inner liner. The device may include electronics for monitoring tire parameters or, in the case of an RFID tag, data that identifies the tire and/or the vehicle to which the tire is mounted. In a conventional attachment of such a device to a tire liner, the device is applied by an adhesive. The device is pressed into the adhesive and the adhesive is left to dry (cure). The contact pressure of the device to the adhesive and the adhesive to the liner is limited to a brief installation time, typically shorter than the entire time for the adhesive to cure. The adhesive is subsequently cured in a room at atmospheric pressure. In such conventional attachments, the result may be a less than adequate adhesive bond between the device and the tire liner. The adhesive may be a layer of rubber specially formulated to bond between the electronic device and the liner, such as in a tire repair patch.

The present invention improves the bond between a device or object and the tire inner liner to which it is attached. An adhesive is applied 12 between the tire inner liner and the object. At least one adhesion enhancing agent is selected 14 from the group: air pressure, steam, moisture, heat, and/or radiation. The adhesion enhancing agent is introduced 16 to the interior of the tire while the adhesive is in an at least partially uncured state. The adhesive is then cured 18 assisted by the adhesion enhancing agent(s) employed.

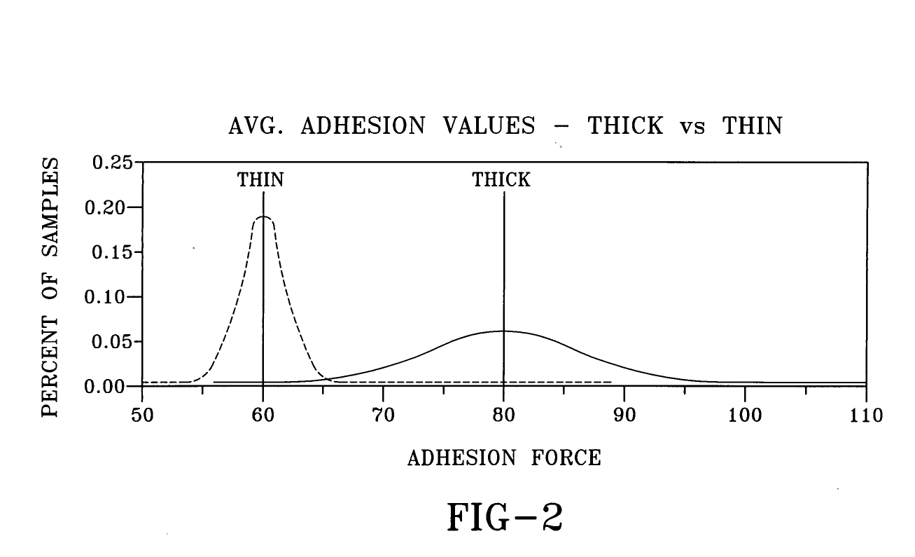

A thick layer of adhesive, as shown in FIG. 2, results in a stronger bond between the object and the tire inner liner. FIG. 2 shows that, in general, a thicker adhesive layer enhances the bond, independent of pressurized application pursuant to the invention. However, a problem with thicker adhesive is that a longer curing cycle is required. With the aid of the adhesion enhancing agent(s) such as pressurized application a thicker adhesive may be employed requiring a relatively long curing cycle time. In the use of air pressure, the subject method inflates the tire while the adhesive is in an at least partially uncured state. The result is that the adhesive dries or cures while under greater contact pressure. Such air pressure may be applied for all or part of the adhesive curing time.

Moreover, the application of air pressure to the tire cavity may be carefully controlled and varied during the adhesion cure time in order to achieve an optimal bond. Initial pressure may be a low value, such as 2-4 psig. Thereafter, the pressure may be gradually increased to a final value. The final pressure value would be a function of the carcass strength of the tire and properties of the adhesive. Thus, air pressure and air pressure operational parameters may be selected to complement adhesive cure properties in order to optimize adhesive cure quality and curing time.

Optionally, other adhesion enhancing agents may be introduced into the tire cavity while the adhesive is in the uncured state and used with or without air pressurization of the cavity. For example, steam, moisture, heat, or other treatments such as UV light in the use of light-curable adhesives may be used to optimize the adhesive curing cycle. The increase in contact pressure between the object to liner interface achieved through inflation of the tire cavity improves ultimate adhesion and optimizes the curing cycle.

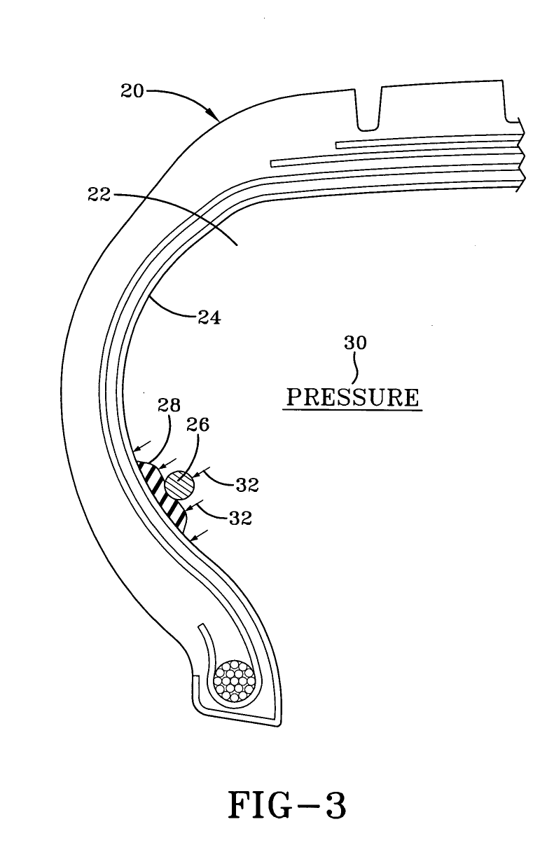

FIG. 3 shows a partial schematic diagram of a tire 20, having a tire cavity 22 surrounded by a tire liner 24. An object, such as an RFID tag or other electronic device 26 is affixed to the liner 24 by means of adhesive 28. Air pressure 30 introduced into the cavity 22 will exert normal force vectors 32 against both the adhesive 28 and the object 26, pressing the object 26 against the adhesive and the adhesive against the liner 24. As a result, an improved bond between the device 26 and adhesive, and the adhesive and liner 24 will be created. Risk of failure of the bond throughout the use cycle of the tire will accordingly be minimized.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A method for attaching an object against a tire inner liner by means of an adhesive, comprising:
a. applying the adhesive in an uncured state between the tire inner liner and the object;
b. adding at least one adhesion enhancing agent to the interior of the tire for enhancing adhesion between the tie inner liner and the object for at least a portion of an adhesion cure cycle.

2. The method of claim 1, wherein the at least one adhesion enhancing agent is taken from group: air pressure, steam, moisture, heat, radiation.

3. The method of claim 1, wherein the adhesion enhancing agent comprises air pressure introduced into the tire to press the object against the inner liner as the adhesive cures.

4. The method of claim 3, wherein further comprising selecting air pressure and air pressure operational parameters to complement adhesive cure properties.

5. The method of claim 3, wherein the air pressure is maintained for at least part of the adhesive cure cycle.

6. The method according to claim 3, wherein the air pressure is varied during at least part of the adhesive cure cycle.

7. The method according to claim 6, wherein the air pressure is increased from an initial value to a final value during at least part of the adhesive cure cycle.

8. The method according to claim 3, wherein the air pressure introduced into the tire is greater than a nominal ambient atmospheric pressure.

9. A method according to claim 3, wherein the air pressure presses the object against the tire inner across substantially an entire footprint of the object.

10. A method according to claim 9, wherein the air-pressure is a force normally directed against an outer surface of the object.

11. A method according to claim 3, wherein further comprising maintaining the air pressure while moving the tire during the adhesive cure cycle.

12. A method according to claim 1, wherein the adhesive is a layer comprising a rubber patch.

13. A method for attaching an object against a tire inner liner by means of an adhesive, comprising:
applying uncured adhesive between the tire inner liner and the object;
selecting at least one adhesion enhancing agent from the group: air pressure, steam, moisture, heat, radiation.
adding the adhesion enhancing agent to the interior of the tire while the adhesive is in an at least partially uncured state; and
curing the adhesive.
